(19) United States
(12) Patent Application Publication
(10) Pub. No.: US 2003/0115101 A1
(43) Pub. Date: Jun. 19, 2003

(54) Advertising system using internet service terminal and method thereof

(76) Inventor: Yong-Man Kim, Kyungki-do (KR)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/296,187

(22) PCT Filed: May 4, 2001
(86) PCT No.: PCT/KR01/00731

(30) Foreign Application Priority Data
May 22, 2000 (KR) 2000/27454

(51) Int. Cl. G06F 17/60

(52) U.S. Cl. 705/14

(57) ABSTRACT

An advertising method using a network service terminal is provided for displaying an advertising web page provided by a service operator (SO) provider on a web page that a subscriber is browsing, wherein the terminal functions as a bridge between a cable network operated by an SO provider and a subscriber's network and which adds an advertising function to the conventional Internet service terminal. The advertising method comprises the steps of converting an IP address of the web server in response to a web request signal from a subscriber's network and an IP address of the advertising web server stored therein into reference IP addresses; producing a frame set file of two window frames having the reference IP addresses as a source, and transmitting it to the subscriber's network; and converting the reference IP address to the original IP address in response to a web request signal for the original IP address from the subscriber's network, and transmitting it to the cable network.

### BACKGROUND OF THE INVENTION

(a) Field of the Invention

The present invention relates to an advertising system and a method using an Internet service terminal, and more specifically, to an advertising system using an Internet service terminal for displaying an advertisement web page on a web page browsed by a subscriber when a web request signal is received from the subscriber, and a method thereof.

(b) Description of the Related Art

Generally, an Internet service terminal such as a cable modem, a network router, ADSL (asymmertric digital subscriber line), xDSL, STB (set top box), PC cards, etc. is installed at a home PC of a subscriber, and functions to connect a subscriber's information terminal of a PC, etc. and a wideband Internet network through a cable network operated by an SO (service operator) provider and a subscriber's network (10-base T Ethernet USB or PC PCI interface, etc.).

In addition, the Internet service terminal functions as a data bridge to exchange various IP packets between a cable network and a subscriber's network. In other words, the Internet service terminal filters the IP packets coming from a cable network and transmits them to an information terminal registered in the subscriber's network and also transmits the IP packets received through the subscriber's network from the subscriber's terminal to the cable network. Further, the Internet service terminal contains various communication functions such as channel scanning, time ranging, power ranging, etc. to make communication through a shared media possible.

However, the function of the conventional Internet service terminal as described above is confined to just being a data bridge between a cable network and a subscriber's network and it is not designed to provide an Internet advertisement function. Therefore, many SO providers have difficulties in maintaining their businesses in the long term because most of their income depends only on the installation and supply fees for the Internet service terminal to a subscriber, and for the Internet service. In addition, subscribers pay fees for the Internet service every month. The above factors for the Internet service and the SO providers become the most serious hindrances to expanding the Internet service business and increasing the number of subscribers.

### SUMMARY OF THE INVENTION

The present invention is directed to provide an advertising system and method using an Internet service terminal to solve the problems and disadvantages of the Internet service system as described above, wherein an advertising web page provided by an SO can be displayed on the web page browsed by a subscriber while he is web-surfing through the Internet service terminal thereby adding an advertising service function to the conventional Internet service terminal.

To achieve these purposes and other advantages in accordance with the present invention, in an advertising system using a network service terminal to perform a function as a data bridge between a cable network operated by a service operator (SO) provider and a subscriber's network, the advertising system comprises: a dynamic host control protocol (DHCP) server for distributing both Internet protocol (IP) addresses necessary for the operation of the network service terminal and various DHCP options; a trivial file transfer protocol (TFTP) server for storing a configuration setup file to control a network service class through the network service terminal, and a file for software upgrade, and for transmitting the files to the network service terminal; a simple network management protocol (SNMP) server for remote-checking and controlling all operating states of the network service terminal; an advertising web server for storing various advertising data and distributing a different content of the advertising data in response to each web request signal; and a router for transmitting signals between the cable network, the DHCP server, the TFTP server, the SNMP server, the advertising web server and the network, wherein the network service terminal converts uniform resource locators (URLs) of the web server, in response to the web request signal from the subscriber's network and the advertising web server stored therein, into reference URLs, and forwards a frame set file of two window frames having the reference URLs as sources to the subscriber's network, and conversely converts the frame set files to the original URLs in the case of receiving the web request signal for the reference URLs from the subscriber's network, and forwards them to the cable network.

In accordance with another aspect of the present invention, in an advertising method using a network service terminal to bridge data between a able network operated by a service operator (SO) provider and a subscriber's network, the advertising method comprises: (a) converting an Internet protocol (IP) address of a web server and an IP address of an advertising web server stored therein into reference IP addresses in response to a web request signal from a subscriber's network; (b) producing a frame set file of two window frames having the reference IP addresses as a source, and transmitting the same to the subscriber's network; and (c) converting the reference IP addresses back to the original IP addresses in response to a web request signal for the original IP addresses from the subscriber's network, and transmitting them to the cable network.

The concluding portion of this specification particularly points out and distinctly claims the subject matter of the present invention. However those skilled in the art will best understand both the organization and method of the operation of the invention, together with further advantages and objects thereof, by reading the remaining portions of the specification in view of the accompanying drawings.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic diagram showing the advertising system using a cable modem according to one embodiment of the present invention; and

FIG. 2 is a schematic flow chart showing the advertising method using a cable modem according to one embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor (s) of carrying out the invention. As will be realized, the invention is capable of modification in various obvious respects, all without departing from the invention. Accordingly, the drawings and description are to be regarded as illustrative in nature, and not restrictive.

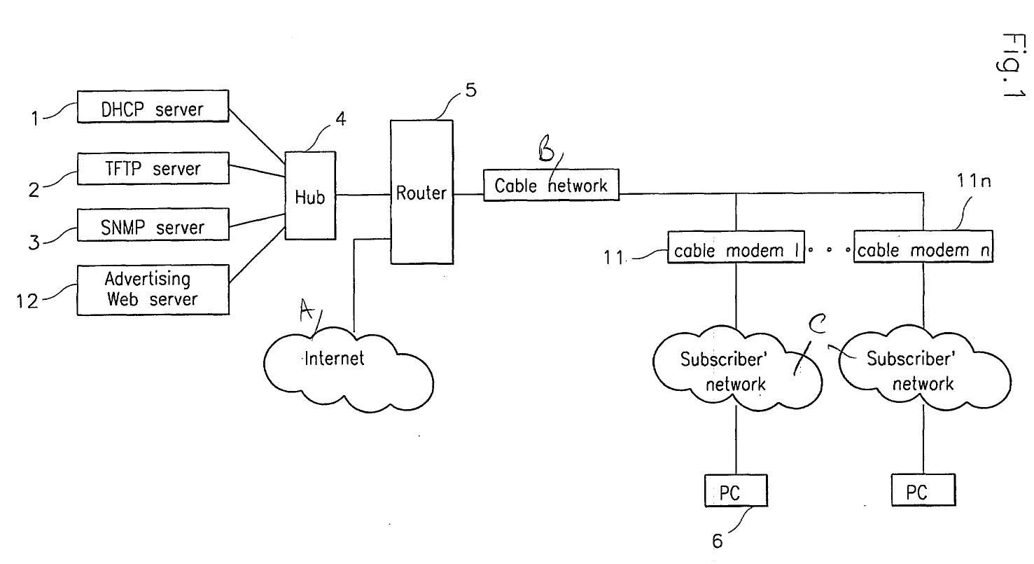

FIG. 1 is a schematic diagram showing the advertising system using a cable modem according to one embodiment of the present invention, and the system comprises a DHCP (dynamic host control protocol) server (1), a TFTP (trivial file transfer protocol) server (2), a SNMP (simple network management protocol) server (3), an advertising web server (12), a hub (4), a router (5) and a cable modem (11).

The DHCP server (1) distributes IP addresses and various DHCP options necessary for the operation of the cable modem (11).

The TFTP server (2) stores configuration files necessary for the control of the service class and files for software upgrade, and transmits them to the cable modem (11) if necessary.

The SNMP server (3) checks and controls all operation states of the cable modem (11) remotely.

The advertising web server (12) stores various advertising data, and distributes a different content of advertisements for each web request signal.

The hub (4) combines the signal transmittal lines of the DHCP server (1), the TFTP server (2), the SNMP server (3), and the advertising web server (12).

The router (5) provides a function to connect different types of network webs, and reduces the work that may be generated unnecessarily in the network by restrictively having the receiving/sending data inside a partial web move only inside the partial web, and transmits the signals among the cable network, the DHCP server (1), the TFTP server (2), the SNMP server (3), the advertising web server (12) and the Internet web.

The cable modem (11) functions as a data bridge to exchange various IP packets between the cable network connected to the router (5) and the subscriber's network connected to a subscriber's terminal (6), and in the case of receiving a web request signal from the subscriber's terminal (6), the cable modem (11) converts the URL (uniform resource locator) of the web server in accordance with the web request and the URL of the advertising web server of the MIB (management information base) data unit stored therein into respective reference URLs, generates files for a frame set of two window frames having the converted reference URL as sources, and forwards them to the subscriber's terminal (6) through the subscriber's network. When a web request signal of the reference URLs is received from the subscriber's terminal (6), the cable modem (11) converts the reference URLs back to respective original URLs and forwards them to the router (5) through the cable network.

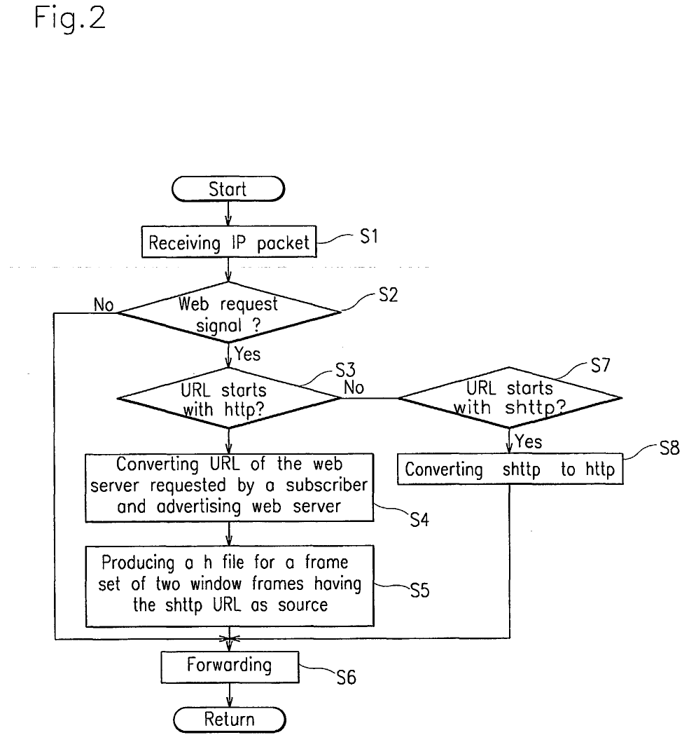

Hereinafter a detailed description of an advertising method using the advertising system using an Internet service terminal according to the present invention as described above will be made referring to FIG. 2 which schematically illustrates a flow chart of the advertising method using a cable modem according to one embodiment of the present invention.

If a subscriber, who uses Internet service through the cable modem (111) as a data bridge to exchange various IP packets between a cable network operated by an SO provider and a subscriber's network, inputs a web request data (http://www.general.com) signal to use specific web server information through a web browser of the terminal (6), an IP packet corresponding to the web request signal is transmitted to the cable modem (11) through the subscriber's network.

While the cable modem (11) is filtering the IP packets received from the subscriber's terminal (6) (S1) and if it receives the IP packet corresponding to the web request data among the filtered IP packets (S2), the modem analyzes the URL source value of the IP packet of the web request signal to determine if it starts with “http://” (S3).

When the URL source of the web request signal starts with “http://”, the cable modem (11) converts the URL of the advertising web server (12) requested by a subscriber and the URL of the advertising web server (12) stored in the inner MIB data unit into reference URLs (S4). For example, the URL of the web server requested by a subscriber, “http://www.general.com” is converted into a reference URL, “shttp://www.general.com”, and the URL of the advertising web server (12) stored in the inner MIB data unit, “http://www.adserver.com” is converted into a reference URL, “shttp://www.adserver.com”.

The cable modem (11) produces a file for a frame set of two window frames, for example html (hyper text markup language) file, stored in the inner MIB data unit such that the web page requested by a subscriber and the advertising page stored in the advertising web server (12) are displayed on the web browser of the subscriber's terminal (6) (S5). At this time, the advertising window frame source of the two window frames to display advertisements is the converted reference URL of the advertising web server (12), “shttp://www.adserver.com”, and the web window frame source to display the web page in accordance with a request of a subscriber is the converted reference URL of the web server requested by the subscriber, “shttp://www.general.com”.

Then, the cable modem (11) transmits the files of a frame set of the two window frames having the converted reference URLs as sources to the subscriber's terminal (6) through the subscriber network (S6). The terminal (6) then analyzes the files of a received frame set, displays the designated advertising window frame and the web window frame, and transmits IP packets to the cable modem (11) through the subscriber's network in order to transmit an advertising content on the advertising window-designated frame and web request data on the web window-designated frame according to the URL information stored in each window frame source to the advertising web server (12) and the web server according to the subscriber's request to show a web page. At this time, the URL source of the IP packet corresponding to the web request data to display the advertising content on the advertising window-designated frame is a reference URL of the advertising web server (12), “shttp://www.adserver.com”, and the URL source of the IP packet corresponding to the web request data to display the web page on the web window-designated frame is a reference URL of the web server requested by a subscriber, “shttp://www.general.com”.

Then, the cable modem (11) receives the IP packet corresponding to the web request signal from the subscriber's terminal (6) through the subscriber's network (S1) (S2), and analyzes the URL source value of the IP packet of the web request signal to determine if it starts with “http://” (S3). However, since all the URL source values of received IP packets start with “shttp://” (S7), the cable modem (11) converts the URL source of the advertising window frame, “shttp://www.adserver.com” into the URL of the original advertising web server (12), “http://www.adserver.com (S8) and then, transmits to the router (5) through the cable network on the side of the SO provider (S6), and converts the URL source of the web window frame, “shttp://www.general.com” to the URL of the original web server requested by the subscriber, “http://www.general.com” (S8) and then, transmits it to the router (5) through the cable network on the side of the SO provider (S6).

At this time, the router (5) transmits a web request signal (http://www.adserver.com) for the advertising web server (12) received through the cable network to the advertising web server (12) through the hub (4). Then, the advertising web server (12) transmits an advertising data file, for example html file, made to display an advertising content stored therein according to the web request signal. Then, the advertising data file transmitted from the advertising web server (12) is transmitted to the router (5) through the hub (4) and the router (5) sends a web data signal for advertising through the cable network to the cable modem (11). The cable modem (11) then receives the IP packet for the advertising data file (S1), and transmits it to the subscriber's terminal (6) through the subscriber's network as received (S6) because the received IP packet is not a web request signal. Thereafter, the subscriber's terminal (6) analyzes the received advertising data file, and displays the advertising content on the advertising window frame. At this time, the advertising web server (12) stores a plurality of advertisements with advertising data files and transmits an advertising data file including a different advertising content according to the inner algorithm at each receipt of a web request signal from the subscriber's terminal (6).

In addition, the router (5) transmits the web request signal (http://www.general.com) for a web server received through the cable network to the web server connected to the Internet through the hub (4). Then, the web server transmits a web data file, for example html file, made to display a web page stored therein according to the web request signal. Then, the web data file, transmitted from the advertising web server (12) to the Internet, is transmitted to the router (5) through the hub (4), and the router (5) transmits the web request signal to display a web page to the cable modem (11) through the cable network. In addition, the cable modem (11) receives an IP packet for the web data file (S1), and transmits it to the subscriber's terminal (6) as received through the subscriber's network because the received IP packet is not a web request signal (S6). Then, the subscriber's terminal (6) analyzes the received web data file, and displays the web page requested by the subscriber on the web window frame.

The cable modem (11) includes a MIB data unit comprising an advertising service enable/disable setup data, frame set data for an IP address (URL) of the advertising web server (12) and two window frames, service class data for advertising, and data for checking the number of times the advertising is accessed, etc. The advertising service enable/disable setup data makes the advertising service for a subscriber enabled/disabled, and only in the state of enabled service can advertising be displayed on the subscriber's terminal (6) through the cable modem (11) by two window frames when the subscriber accesses a web page. The frame set data is to produce an IP address (URL) for the advertising web server (12) and two window frames and to store files for an IP address (URL) of the advertising web server (12) to show the advertising on the subscriber's terminal (6) in the case of receiving a web request signal of a web server by the subscriber and for a frame set to show two window frames including advertising on the subscriber's terminal (6). The advertising service class data is to control a degree of the advertising display, and the service provider controls the optional functions such as the size of the advertising window according to a service request from a subscriber, an advertising update, the subscriber's selection of the disable function for the advertising, etc. The advertising access number checking data says the number of times of the web request signals transmitted through the cable modem (11) to the advertising web server (12) which is necessary to determine the fees, etc.

The content of the MIB data unit can be checked through the SNMP server (3) to check and control the operational state of the cable modem (11) on the side of the SO provider, and the setup data of the MIB data unit stores a configuration setup file necessary to control an Internet service class and a software upgrade file, and can be controlled by the operation of the TFTP server (2) on the side of the SO provider to transmit through the cable modem (11) if necessary.

Though the above description of the embodiment of the present invention has been made only for a cable modem, the present invention can be applied on almost all kinds of Internet service terminals including a network router, ADSL, xDSL, STB, PC cards, etc., and the advertising web server (12) can also be located in a third place without being installed on the side of an SO provider.

As described above, the present invention provides an SO provider with advertisement benefits by operating an advertising service through an Internet service terminal to function as a data bridge between a cable network operated by the SO provider and a subscriber's network, and a subscriber can also benefit by using the Internet service with a lower price in the case that the SO provider shares a part of the benefits of the advertising income with subscribers. Further, if the user fees for the service decreases, the number of subscribers can increase and the advertisers can see more effective advertising results. Therefore, SO providers can earn more advertising income and provide subscribers with more benefits.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An advertising system using a network service terminal to perform a function as a data bridge between a cable network operated by a service operator (SO) provider and a subscriber's network, the advertising system comprising:
a dynamic host control protocol (DHCP) server for distributing both Internet protocol (IP) addresses necessary for the operation of the network service terminal and various DHCP options;
a trivial file transfer protocol (TFTP) server for storing a configuration setup file to control a network service class through the network service terminal, and a file for software upgrade, and for transmitting the files to the network service terminal;
a simple network management protocol (SNMP) server for remote-checking and controlling all operating states of the network service terminal;
an advertising web server for storing various advertising data and distributing a different content of the advertising data in response to each web request signal; and
a router for transmitting signals between the cable network, the DHCP server, the TFTP server, the SNMP server, the advertising web server and the network,
wherein the network service terminal converts uniform resource locators (URLs) of the web server, in response to the web request signal from the subscriber's network and the advertising web server stored therein, into reference URLs, and forwards a frame set file of two window frames having the reference URLs as sources to the subscriber's network, and conversely converts the frame set files to the original URLs in the case of receiving the web request signal for the reference URLs from the subscriber's network, and forwards them to the cable network.

2. The advertising system using a network service terminal according to claim 1, wherein the network service terminal further comprises a management information base (MIB) data unit for storing advertising service enable/disable setup data, frame set file data for producing the IP addresses and the two window frames of the advertising web server, advertising service grade data, and inquiry data for advertisement access times.

3. The advertising system using a network service terminal according to claim 2, wherein various data of the MIB data unit are checked by the SNMP server.

4. The advertising system using a network service terminal according to claim 2, wherein various data of the MIB data unit are controlled by the TFTP server.

5. The advertising system using a network service terminal according to one of claims 1 to 4, wherein the advertising web server is connected to the router through the network.

6. An advertising method using a network service terminal to bridge data between a cable network operated by a service operator (SO) provider and a subscriber's network, the advertising method comprising:
(a) converting an Internet protocol (IP) address of a web server and an IP address of an advertising web server stored therein into reference IP addresses in response to a web request signal from a subscriber's network;
(b) producing a frame set file of two window frames having the reference IP addresses as a source, and transmitting the same to the subscriber's network; and
(c) converting the reference IP addresses back to the original IP addresses in response to a web request signal for the original IP addresses from the subscriber's network, and transmitting them to the cable network.

7. The advertising method using a network service terminal according to claim 6, wherein (c) further comprises: storing data on the number of times web request signals are input in an inner MIB data unit in the case that the reference IP address is an IP address of the advertising web server.

8. The advertising method using a network service terminal according to claim 6, wherein (b) further comprises: the window frame having the reference IP address of the advertising web server as a source being produced with optional functions including an advertising window size stored in the MIB data unit, a degree of advertising update, and a subscriber's selective advertising disable setting.

9. The advertising method using a network service terminal according to claim 6, wherein (a) further comprises:
converting the IP address of the web-server according to the web request signal and the IP address of the advertising web server stored therein into reference IP addresses only in an enable state of the advertising service according to advertising service enable/disable data stored in the inner MIB data unit in the case of receiving a web request signal from the subscriber's network; and
transmitting the web request signal received from the subscriber's network to the cable network in a disable state of the advertising service.
